(19) United States
(12) Patent Application Publication
(10) Pub. No.: US 2025/0051152 A1
(43) Pub. Date: Feb. 13, 2025

(54) Robotic Rail IBC Handler

(71) Applicant: Ming Zhang, Montreal (CA)

(72) Inventor: Ming Zhang, Montreal (CA)

(21) Appl. No.: 18/448,904

(22) Filed: Aug. 11, 2023

(51) Int. Cl. B66F 9/19

(52) U.S. Cl. CPC B66F 9/19

(57) ABSTRACT

Disclosed is an outdoor mobile robot manipulator for the automatic handling of railway inter box connectors (IBC) in an intermodal rail yard. The manipulator includes a dual-mode adaptive suspension for protection of the robotic arm and end-effector against shock and vibration, a universal fingerless gripper capable of manipulating main types of rail IBCs, a blind IBC type recognition based on force sensor and close-range proximity sensors, and other protection gears enabling the manipulator to work in harsh outdoor working environments.

### FIELD OF THE INVENTION

The present invention relates generally to the field of automation of railway operation by the application of robot arms. More particularly, the invention relates to
(1) the application of an unmanned mobile robot manipulator for automatic handling of railway inter box connectors, referred to herein afterward as IBC, for securement of a top shipping container to a bottom shipping container carried by a well type intermodal railcar;
(2) the protection of mobile robotic equipment and sensors exposed to the outdoor harsh working environment to ensure reliable and repeatable robotic rail IBC manipulation.

### BACKGROUND OF THE INVENTION

Modern intermodal railway freight transport uses railcars to carry two layers of cargo containers to be stacked one on top of another, often referred to as double-stack rail transport. While the bottom container is secured within the rail car, the top container must be secured safely with the bottom container using inter box connectors, referred to herein afterward as IBCs.

The shipping containers, dry or liquid type, that railcars transport are typically of standardized size and shape with standardized corner fitting (or castings) for interconnections using inter box connector (IBC) or in other terms, twist-lock stacking pins. Due to the North American railroad interchange system, a large number of low-cost, rugged manual rail IBCs of different styles are mixed used. The handling of those rail IBCs requires human intelligence to recognize the kind of rail IBC and conduct different locking and unlocking procedures.

The handling of IBC has been a serious safety hazard, an efficiency drag, a heavy burden, and a roadblock for other efforts to automate the railway yard operation dealing with shipping containers. The burden consists of the labor cost and loss of operational efficiency due to the manual process steps to lock, unlock, place, and remove those IBCs in every step of container loading and unloading. Furthermore, wherever there is manual IBC handling, the present railroad safety codes forbid any pass of crane trolleys therefore a safety exclusion zone must be created.

The steps of manual handling of IBC by a groundsman in an intermodal yard include:
climbing up the side of the bottom container in each car to place IBC into each corner casting of the bottom container during container loading;
manually locking each IBC by rotating the protruded handler by 90 degrees to its fully locked position after the top container is loaded on top of the bottom container during container loading;
manually unlocking each IBC by rotating the protruded handler by 90 degrees to its fully unlocked position before the cranes can lift the top container from the railcar;
removing the IBCs from each corner casting of the bottom container and placing them in a storage cabin of which the location is specific to the type of the rail car before the bottom container can be unloaded from the railcar or transported to other locations;
certain logistics of IBCs within the railway yard to prevent loss and eliminate safety hazards.

Not only time and labor-consuming, but such a manual operation is also dangerous, particularly in bad weather, being a source of injuries or casualties. Some railroads use diesel-powered raised deck mobile carts driven by a groundsman known as cone cart grunt to perform the IBC related handling. Nevertheless, the safety risk and operational inefficiency remain. There has been a strong desire in intermodal terminals to introduce automation of manual handling of the IBCs.

The semiautomatic or fully automatic IBCs were developed in history but never applied on large scales due to various issues found in their field trials related to long term reliability and operational efficiencies. For example, the prior art reference U.S. Pat. No. 9,011,055 “Automatic lock for cargo container”, U.S. Pat. No. 9,809,358 “Self-Latching Interbox Connector For Automatic securement of a top container to a bottom container”, U.S. Pat. No. 8,342,786 “Container Auto-Lock System”, Patent Application #20160251021 “Connector System For Securing Stacked Containers”, Patent Application #WO2012141658A2 “Device for handling an inter-box connector”, U.S. Pat. No. 10,611,291 “Locking system and method of use”.

Unfortunately, none of the above is widely implemented in railway operation due to many constraints from the legacy issues of a large number of existing IBCs in use, demanding railway safety regulations, and practical railway operation conditions,

Attempts to develop automatic IBC operation devices onboard railcars were also made to save precious spaces in the yards and be realized efficiently on all cars simultaneously. However extra tare weight added to the moving transport equipment is never desirable, especially for the profit-driven freight transport system.

The new generation of robots armed with sensors, robotic vision, and intelligence is a perfect candidate to automate the rail IBC handling if a set of auxiliary equipment and application-specific tools can be developed and integrated into a reliable system to enable the robots to adapt to the rail yard working conditions.

Nowadays robot fabrication performing many repetitive functions including pick-and-place in a controlled indoor environment is common and referred to as the application of stationary industrial robots along a production line or production site that operates under fixed conditions with a limited working area guarded by a safety fence. Unfortunately, such a mature system is difficult to adapt to fragmented outdoor railway operations.

No filed patents are found dealing with equipment or methodology to automate the manual handling of railway IBC in the rail intermodal terminal. Furthermore, no filed patents are found dealing with any type of shipping container twist lock by using ground mobile robots.

A force-limiting cobot, an abbreviation for the collaborative robot manipulator, coupled with an AMR or an AGV, abbreviations for the autonomous mobile robots or the automatic guided vehicles offer general dexterity and short-range mobility. There exist several mobile manipulation systems that have been successfully applied in controlled indoor environments. However, when the mobile robots are placed in an outdoor environment, technical challenges increase largely in the following aspect:
limited onboard battery energy, shared already between mobile robots, robot manipulators, as well as end effectors, can be reduced by 80% in cold temperatures, demanding deployment of large and heavy power sources, for example, large-and-heavy diesel engines or electric batteries;
precise and stable robot manipulation in terms of pose repetitiveness, already difficult to achieve in raised heights above the ground, must be able to withstand cold frozen temperatures, windy, rainy, and snowy weather;
service life of the sensitive robot arm, its delicate electronic control box, and other sensors can be severely affected by vibration and shock witnessed during outdoor travel in the rail yard. Excessive vibrational energy may damage or cause deterioration of the electronics and mechanical components contained in the robot manipulators, which can significantly shorten the service life of the robot manipulator;
a narrow passage between the rail tracks in the already crowded rail terminal that the designed mobile manipulator must share with human operators, ground wheeled equipment, rubber-tired-gantry cranes/rail-mounted-gantry cranes that forbid the use of large footprint equipment;
dysfunction of electric or electronic devices in cold frozen weather.

Meanwhile, the smooth and sleek contour of railway IBC poses a unique challenge for the conventional robotic gripper to grasp and hold, especially when there are different styles of railway IBCs made in normally loose tolerances.

The general challenges and technology gaps encountered by the mobile robot arm in terms of vibration and shocks are summarized below. When mounted on a vehicle, for example,
the robot manipulator onboard a road vehicle undergoes road vibration which at times may be extreme due to the condition of the road and encounter severe shock when the vehicle hits potholes or goes over railroad crossings;
the robot manipulator onboard a marine or aerial vessel experiences underwater explosion or turbulences,
other forms of transportation in the future carrying mobile robotic manipulator systems. experiencing vibrational inputs.

Such vibration and shock can be quite intense and greatly increase the failure rate of the robot manipulator systems. Robots, as sophisticated machinery, can incur significant upfront investment that expects quick payback and long service life to maximize the return on capital.

The vibration and shock forces received by the vehicle, while primarily occurring in the vertical direction with respect to the ground can also occur in nearly all directions of the mounting system. A need thus exists for vibration and shock isolation mounts for the mobile robot systems onboard such a vehicle or virtually any form of transportation to minimize such forces in essentially all directions.

Because of above listed difficulties, conventional robot application is restricted to performing many repetitive tasks in a controlled indoor environment and is classified as a stationary industrial robot. The base of a stationary industrial robot, with the manipulator, is typically fixed to a stationary foundation firm enough to support the manipulator sufficiently to endure the reaction forces produced by the robot and to assure precision capture and manipulation.

Mobile robot manipulators do exist by mounting the lightweight flimsy collaborative robot (cobot) manipulator directly to the deck of a lightweight carrier or mobile platform. However, It is challenging to achieve a reasonable level of manipulation precision, operational repeatability, and efficiency with the present mobile robot manipulator. They move slowly, manipulate imprecisely, and struggle with the intrinsic conflicts between the required mobile cushioning capability and the stationary stability only achievable by a rigid base foundation.

Auxiliary equipment such as robotic vision, sensors, and electric control box also suffers when they are onboard a vehicle traveling on rugged terrain. The severe jarring forces or vibrations that are imparted on the vehicle chassis during transportation are transferred directly to the dedicated electronic and precision mechanical components resulting in either damaged components or destroyed precisions. Likewise, the electronics external to the manipulator, such as the control box, sensors, and the battery may also be subject to damaging forces that may be imparted upon similarly during transportation.

The mobile robot manipulator faces another efficiency challenge when it moves frequently from location to location, performing fragmented outdoor unmanned operations. Different from a scientific discovery mobile robot manipulator with high demand on adaptability to any unknown or irregular environment, the outdoor manufacturing mobile robot manipulator is programmed to accomplish a repetitive manufacturing mission at high speed, but in a known, ordered environment, for example, a work cell where many local geometrical relationships among objects such as a workbench, jig, components, tools, tool holders are consistent. Those outdoor manufacturing or commercial servicing activities put a lot of emphasis on operating time, speed, and efficiency which are less of a priority to a scientific discovery mission.

As a matter of fact, if the initial base position and posture of a robot manipulator can be standardized or fixed relative to a datum block within the work cells at every new location, for example, when the mobile robot arrives at a new location, it is always guided to and secured firmly against a surface of a datum block with the known geographical feature, it will greatly simplify the initial self-detection and self-calibration of the robot manipulation at each new location and save precious on operating time, power consumption, etc.

Therefore, there are three major challenges for the mobile robot manipulator application:
(1) vibration and shock received during transport that can potentially destroy the precision and shorten the service lives of the robot manipulator;
(2) lack of rigid and stable foundation support can reduce the operation reliability;
(3) frequent self-detection and self-recalibration at every new location takes time and energy and impart operation efficiency.

Numerous patents are found dealing with vibration and shock isolators for the electronic device onboard a mobile vehicle, for example, the prior art reference
U.S. Pat. No. 6,530,563 “Multi-axis shock and vibration isolation system”;
U.S. Pat. No. 6,290,217 “Asymmetric wire rope isolator”;
U.S. Pat. No. 6,286,805 “Apparatus and method for transporting equipment between buildings”;
U.S. Pat. No. 5,549,285 “rope isolator with crimp bar and method for making same”;
U.S. Pat. No. 9,765,846 “Positioning apparatus mounted with vibration isolators and robot” describes an apparatus to control the vibration inputs from an operating robot manipulator moving either at slow speeds or high speeds, to a precise rotating lathe or turning inspection devices that are already cushioned by vibration isolators to isolate originally the vibration input from the floor;
U.S. Pat. No. 10,557,518 “Vibration isolation device”, describes a vibration and shock isolator applied to a monitoring device mounted to a moving body including a lift.

However, no filed patents are found dealing with a dual-mode suspension apparatus capable of protecting the mobile robot manipulator itself against external vibration and shock input in a transport mode, and at the same time capable of helping stabilize the mobile robot manipulator sufficiently for performing its capture and manipulation task in a work mode.

Numerous devices have been created to isolate damaging shock and vibrations and isolate unwanted kinetic energy by directing it to move springs or pistons, therefore diverting the unwanted energy from the shock-sensitive equipment attached to the isolator and then dissipating it by energy absorption devices. Wire rope isolators and elastomeric isolators are two good examples.

The application of wire rope shock absorbers become more and more popular in all kinds of aerial, marine, and ground vehicles to protect electronic devices and precision electromechanical equipment. The large deflection capability and potentially good damping properties make them ideal, in many cases, for shock attenuation, but less effective for vibration isolation. The shock isolator requires a certain amount of dynamic displacement capability to extend the response time for coping with the induced displacement.

The application of elastomeric isolators designed for a specific narrow range application is also a common practice. The relatively low stiffening coefficient tuned into the elastomeric isolators enables them to perform well where vibration isolation is required but tends to leave them with decreased efficiency for attenuating shock. The vibration isolator should exhibit a low dynamic stiffness in order to achieve the required amount of isolation.

In general, a moving vehicle is exposed to many different vibration and shock inputs. The implementation of isolators for vehicle applications requires the consideration of both shock and vibration inputs. A solution that is optimal for shock isolation may not offer sufficient vibration isolation. Compromises are often made based on specific equipment isolation requirements.

Therefore, there is a need for the development of a convertible base suspension of a mobile robot manipulator that can serve as an isolator, an anchor, and a datum depending on the circumstances:
isolating the shock and vibration when the mobile robot manipulator travels in transport mode;
switching instantly into a locked mode from the transport mode;
self-aligning with a datum block of the known geographical feature and known geometrical relationship at the desired location, providing an initial datum when the mobile robot starts its programmed activities.

Another serious operational challenge related to the rail IBC handling is to remove the rail IBC frozen inside the corner fitting. The forceful removal of the frozen IBC is often accompanied by damaged material and severe safety risks.

### SUMMARY OF THE INVENTION

It is an object of the present invention to replace humans with a mobile robotic rail IBC handler with a robot manipulator, either a semi-automatic or fully automatic robotic rail IBC handler. The robotic rail IBC handler employs a commercially available robot arm to perform all the steps of rail IBC detection, recognition, and handling. The robotic rail IBC handler includes auxiliary protective gears for the robot and sensitive equipment against vibration, shock, and adverse weather conditions.

The semi-automatic robotic rail IBC handler performs automatic handling of the rail IBC at height, while it is mobilized by a forklift manually driven on the ground. The fully automatic robotic rail IBC hander performs all the tasks as the semi-automatic one, plus it employs an autonomous mobile robot (AMR) such as a fully automatic forklift capable of self-navigation in a rail intermodal terminal and collision avoidance.

The mobile robotic rail IBC handler comprises a mobile carrier capable of ground displacement and vertical lift, a robotic equipment module mounted on a pallet, and a multiple-level spare IBC module mounted on a second pallet. The equipment module and the spare IBC module can either be coupled and transported together or individually by the forklift.

The rail IBC handling operation can therefore be categorized into three groups of robotic manipulation steps:
(1) angular movements of the rail IBC relative to the corner fitting performed by a robot;
(2) robotic pick and place of the rail IBC relative to the corner fitting;
(3) robotic pick and place of the rail IBC relative to the spare rail IBC stands.

Replenishment of the spare rail IBC stands may also be achieved by a robotic forklift.

It is another object of the present invention to protect selectively the mobile robot manipulator and its auxiliaries during transport from damages originating from random shock and vibratory forces acting along the three primary axes. More specifically,
two separate suspended kits are created, one with an instant locking mechanism for the stability-hungry robot arm, and the other conventional one for the sensitive electronic control box. Both suspended kits are floatingly supported by the carrier frame through a plurality of wire rope shock isolators and elastomeric vibration isolators so that they act in unison to attenuate shock and vibrations acting along the vertical, horizontal, and longitudinal axes.
the lockable one called lockable base suspension comes with a controller and parallel-gripping clamp capable of switching between locked and unlocked mode, securing in the locked mode the robot base to a preplanned position and posture relative to the external datum, in this case, the corner fitting of the container, while giving sufficient three dimensional freedom of movement to the robot arm and its suspension in the unlocked mode;
the suspended kit may be locked into an external datum directly, or locked into the support base first and then locked further into the external datum through secondary locking between the support base and the external datum. The locking is achieved by a linear actuator, with or without the assistance of electromagnets.

It is another object of the present invention to provide a speedy and reliable position and displacement detection system powered by sensors, achieving a speedy initial setup of the same robot manipulator at every desired location.

Those positioning and displacement sensors are grouped into two categories, one group of long range sensors to instantly sense and indicate the approximate position with relatively large tolerance, and another group of close-range sensors including the contact type sensors, to detect precisely the location within the approximate range already.

It is another object of the present invention to provide a universal rail IBC gripper that can handle all types of IBC, in various tough working conditions including frozen cold weather. The gripper is capable of performing deicing and extracting or inserting rail IBC into the frozen corner fitting. Pragmatic algorithms are provided to distinguish the types of rail IBC encountered and manipulated even when the robotic vision fails.

It is another object of the present invention to provide a heating and ventilation system, powered substantially by the afterheat or waste heat of the mobile carrier, creating a friendly internal working environment for the robot manipulator, electric control box, sensors, and other electronic devices, under a harsh external outdoor condition, especially the humid or frozen one.

### BRIEF DESCRIPTION OF THE DRAWINGS

Other uses and advantages of the present invention, overcoming the limitation of the prior arts, will become apparent to those skilled in the art upon reference to the specification and the drawings, in which:

FIG. 1 shows a typical intermodal rail car carrying two double-stacked cargo containers.

FIG. 1A shows a close-up view of one top corner of the cargo container including a corner post, a corner fitting (or casting), and a typical inter box connector to be inserted into the corner fitting.

FIG. 6 (a) and FIG. 6 (b) present two side views of a wire rope shock isolator and floating elastomer vibration isolators that are connected in series.

FIG. 7 presents a general arrangement of a robotic rail IBC handler mobilized by a forklift. A modular robotic equipment pallet is lifted to the top of the lower container on board an intermodal railcar.

FIG. 7A presents a top view of the robotic rail IBC handler transporting both the modular robotic equipment pallet and the modular spare IBC pallet from one location to another along a container carried by an intermodal train.

FIG. 7B presents a top view of the robotic rail IBC handler stopping at a corner post and lifting the modular robotic equipment pallet to reach the corner fitting while leaving the modular spare IBC pallet on the ground.

FIG. 7C shows a close-up view of the corner fitting and the end of the modular equipment pallet to be engaged with the corner fitting, depicted in FIG. 7B, showing the details of the long range non-contact type position sensor and close range contact type position detectors.

FIG. 7D presents a side view of a plunger type limit switch, an example of the close range contact type position detector shown in FIG. 7C.

FIG. 7E presents an isometric view of the fingerless IBC gripper holding a rail IBC by the two actuator rods inserted between the bottom of the top cone and the top of the shoulder flange. The embodiment is especially useful to handle the type of rail IBC without an aperture in its top cone.

FIG. 7F presents an isometric view of the fingerless IBC gripper holding a rail IBC by the mid actuator rod inserted into the aperture in the top cone. The FIGURE also presents deicing tools mounted to the gripper including the deicing rod with spikes, the deicing material spray nozzle, and the hot air blowing nozzle.

FIG. 7G presents a front side view of the fingerless IBC gripper shown in FIG. 7F. The FIGURE also shows the different options of adding contact type or close range non-contact type sensors to the gripper.

FIG. 7H presents an isometric view of one embodiment of the present invention where two types of integrated suspension are incorporated into the same modular robotic equipment pallet. One is the lockable base suspension for the robot arm and the other is the similar suspension for the robot electric control box without a locking feature.

FIG. 7J presents a front side view of the modular robotic equipment pallet shown in FIG. 7H.

FIG. 7K presents a top view of an alternative embodiment of the present invention where four linear actuators instead of two as presented in FIG. 7H is incorporated into the lockable base suspension. The FIGURE also shows the arrangement of additional telescoping guide tubes.

FIG. 7L presents an end view of the embodiment shown in FIG. 7K.

FIG. 7M presents a schematic diagram showing the functional principle of a heating and ventilation unit integrated into the robotic rail IBC handler, taking advantage of the after heat generated by the forklift engine.

### DESCRIPTION OF THE PREFERRED EMBODIMENTS

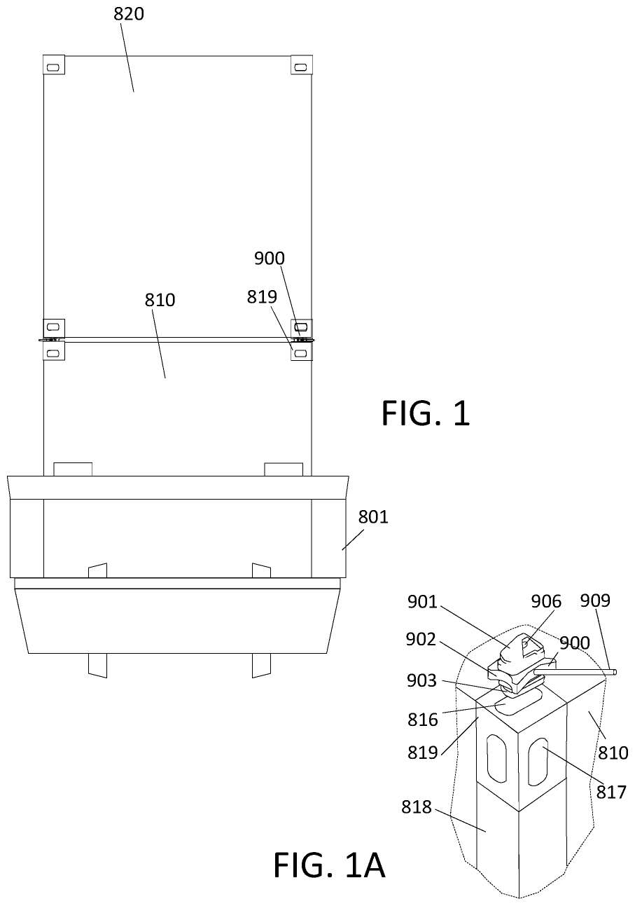

In FIG. 1, an intermodal rail car 801 carries double stacked containers 810 and 820 connected by four inter box connectors 900 sitting inside corner fittings 819.

In FIG. 1A, a typical inter box connector (IBC) 900 is ready to be inserted into the top corner casting 819. The corner casting, also called corner fitting is welded into and supported by the corner post 818 of the container.

The IBC 900, each weighing about 6 kg, works like the twist lock that the crane uses to grasp the container in the marine or rail intermodal terminal. The top cone 901 and bottom cone 903 of the IBC 900 are one piece of cast steel and are shaped like the letter “I”. The top cone 901 is pointed to make it easier to insert into the lower corner casting of the top container and the bottom cone 903 is essentially a flat rectangular cuboid.

Several types of IBC made by the company BUFFER USA, GENERAL LASHING SYSTEM, PECK & HALE, and MARTEC INTERNATIONAL are approved by the Association of American Railroad (AAR) and are mixed used in the railway network. Some models of rail IBCs have aperture 906 created at the top cone 901 while others do not have such aperture. All rail IBCs have extended handles 909, some projecting from the shaft in the middle to the front of the IBC while others point to the side of the IBC depending on the models.

The shoulder flange 902, surrounds the center shaft and separates the top cone 901 from the bottom cone 903. The two stacked containers are therefore separated by the shoulder flange 902 once they are connected by the IBC. There is a slot created in the shoulder flange 902 for the handle 909 to turn into different angular positions.

Although all rail IBCs fit into the corner fitting with almost identical contours, different models of IBC have different profiles and are operated differently, requiring at present, human intelligence to recognize the types of the IBCs and operate them differently.

The corner fitting 819 is manufactured following an internationally recognized technical standard. It has three cavities on its external surfaces, a stacking hole 816 on the top with the tapered rim to facilitate the entry of the rail IBC and a stadium hole or shield hole 817 on the sides.

The known and controlled geometries of the corner fitting, and corner post serve in the present invention as an important external datum. For example, the centerlines of the three holes are aligned in a consistent manner. therefore it is sufficient to scan the positions of the stadium hole or the shield hole from the sides, the location of the stacking hole can be determined.

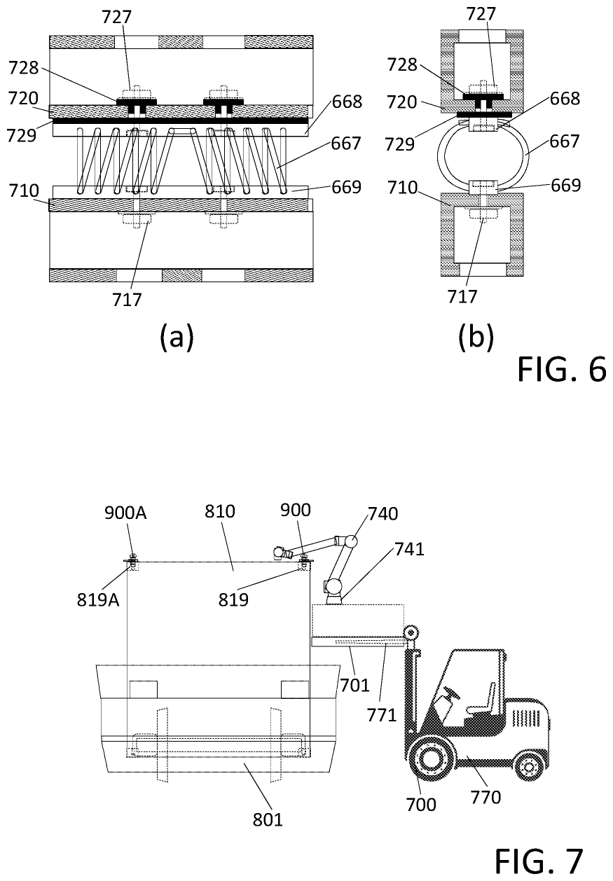

As shown in FIG. 6, each wire rope isolator applied in the present invention has a central spring element 667 and two mounting block members 668 and 669 securing the spring element 667. The spring element 667 is essentially wire rope made in stainless steel, which permits the mounting block members 668, as well as suspended kit 720 to move in virtually any direction relative to the mounting member 669 or the base support 710.

The wire rope isolator deflects under load, bending the wire cables that create a spring force and in turn offers non-linear elastic support to the component in suspension. Generally, the spring member enjoys a long fatigue life if the vibration amplitude reaches only 20% of the maximum displacement limit and the shock amplitude reaches only 50% of the maximum displacement limit.

The benefit of using wire-rope isolators instead of spring lies in the fact that when the multi-strand wire rope isolator flexes, friction is created between the wire strands, and a damping effect is created by converting the kinetic energy into thermal energy which ultimately dissipates into the environment, while the regular single strand spring offers insignificant amount of damping.

Also shown in FIG. 6, using pair of one elastomer bushing 728 and one elastomer washer 729, a floating mount is created around the fastening screws, nuts, and washers assembly 727 that isolates the suspended unit 720 from any metal-to-metal contact with the wire rope spring and the base support 710.

The elastomeric vibration isolator can be made in any suitable type of material, including but not limited to cellular rubber material, silicone, polyurethane or polyurethane foam, thermoset polyether-based polyurethane material, material under the trade name Sorbothane, Poron, Bisco, Griswold. with a selected range of stiffness measured by the shore hardness scale, for example between 30 and 80 shore A.

Instead of using a wire rope isolator, other suitable suspension and damping systems may be used, for example, using conventional or commercially available components such as conventional spring members with dampers and/or shock absorbers mounted to sliding skid or caster wheeled cart that is pivotally connected to the rigid carrier frame through a ball joint.
Other integrated shock and vibration options are also foreseen, for example,
the elastomeric material formed into a profile that envelops the entire wire rope isolators such as the high energy rope mount (HERM) manufactured by ENIDINE;
Other double-acting shock absorbers with elastomeric rod end pivotally attached to the suspended kit using ball joint etc.
the elastomer pad that is put underneath the battery to increase its service life.

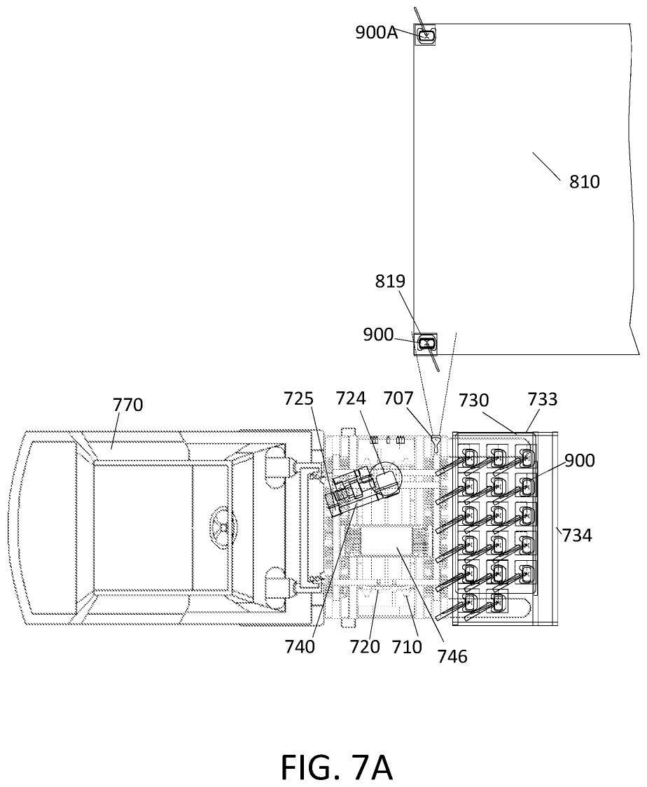

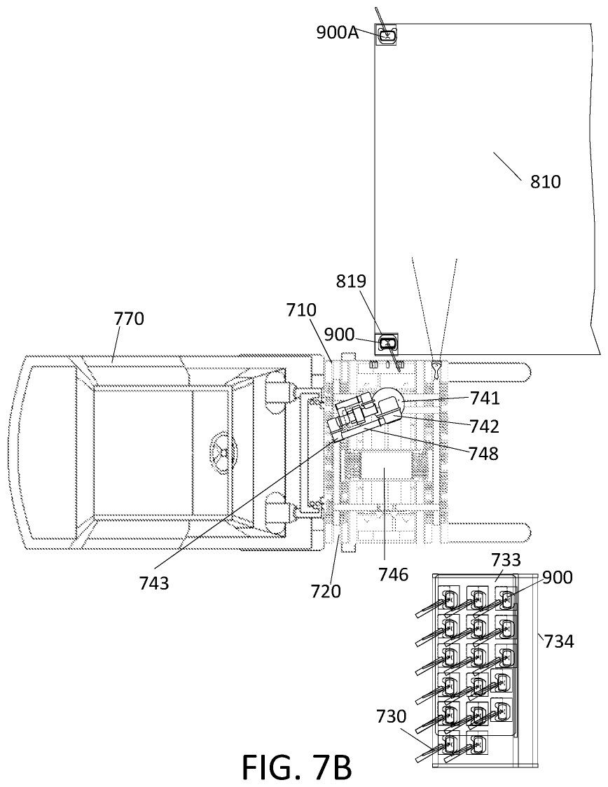

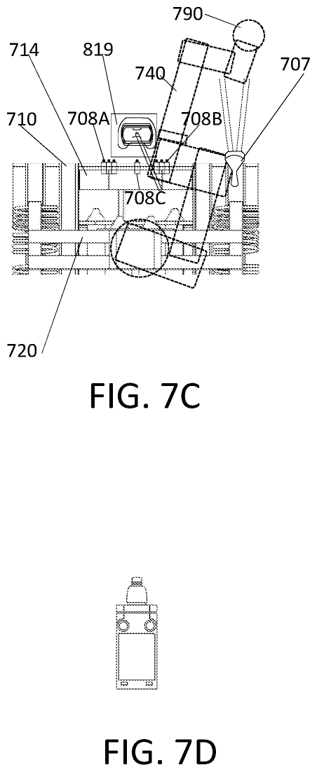

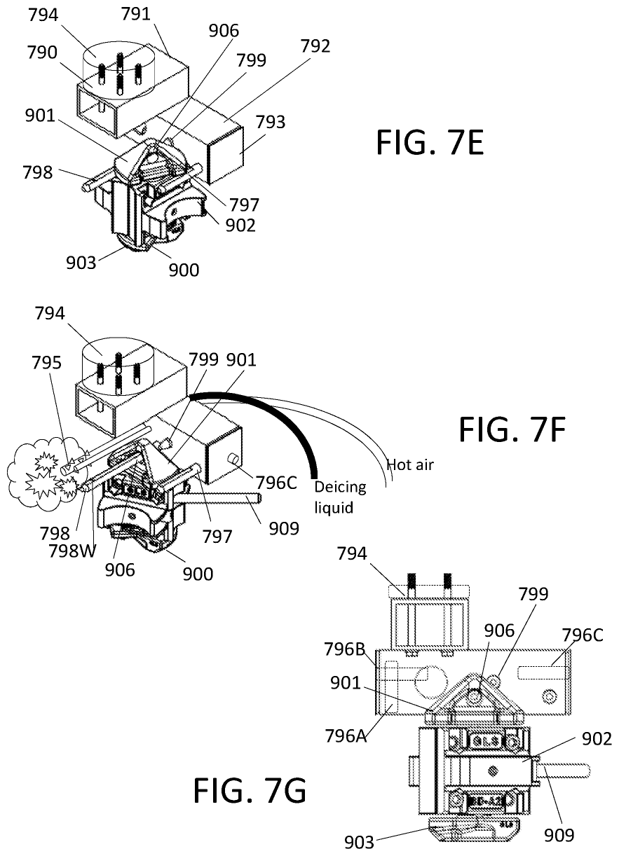

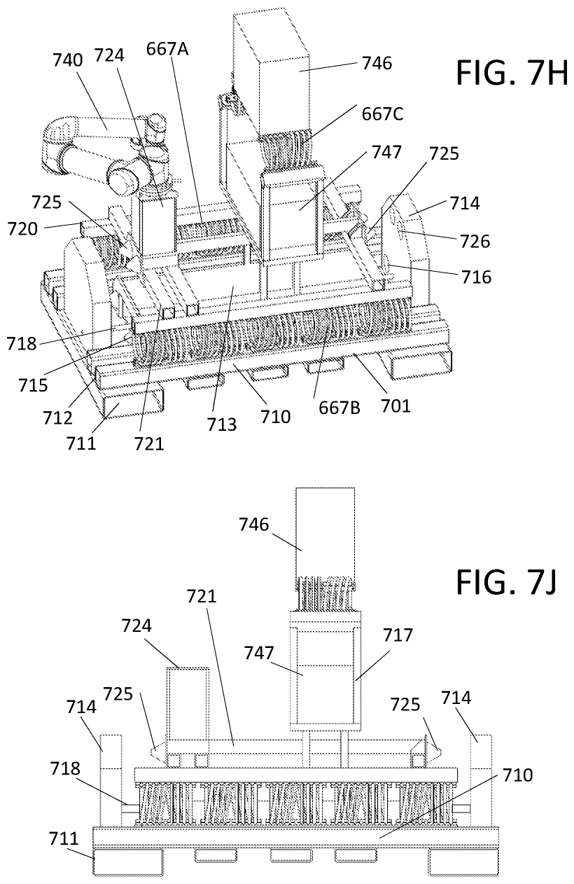

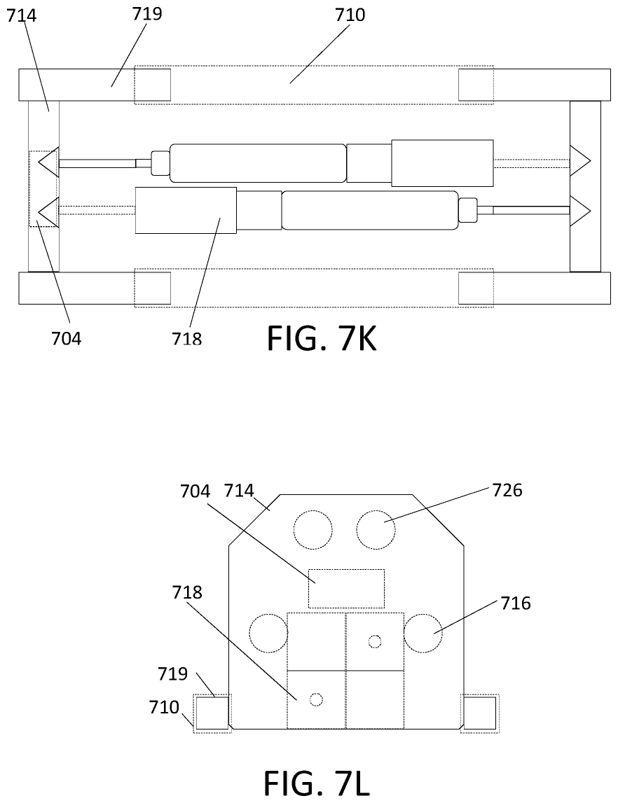

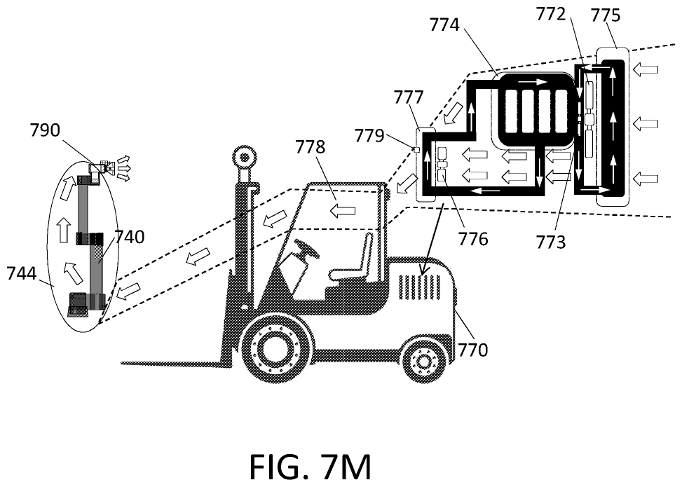

FIG. 7 schematically illustrates an application of the lockable base suspension for a robot manipulator to handle a railway inter box connector (IBC) employed in a double-stacked container train. As shown in FIG. 7, a railway well car 801 is employed to haul double-stacked containers secured by four inter box connectors. In this view, the top layer container is removed, one IBC 900A is in a locked mode indicated by its handle shifted to the left, and the other IBC 900 is in an unlocked mode indicated by its handle shifted to the right.

The detail of the modular robotic equipment kit 701, symbolically presented here as a box in a dotted line will be revealed in detail in other figures. The modular equipment pallet 701, including a robot manipulator 740, carried by a forklift 770, is employed to lock, unlock, place, and remove the inter box connector from the corner fitting 819 or 819A before unloading the bottom layer container 810.

The mobile carrier, either an autonomous forklift, a manually driven forklift with a protective cabin for the human driver, or an equivalent mobile robot with a load lifting capability, may be used to move the modular robotic equipment kit 701 from one railcar to another.

Once the forklift stops at the desired location, in this case, the corner post under the corner casting, under the guidance of sensors and navigation system in the rail intermodal terminal, the forklift 770 raises the equipment module 701 to an appropriate height and pushes the equipment module 701 firmly against the corner post 818 or the corner fitting 819 so that the robot manipulator 740 can perform its desired unmanned handling of inter box connector.

The employment of a magnet or an electromagnet is envisaged to strengthen the contact established between the corner post 819 and the equipment module 701, helping anchor module 701 firmly to the datum block, in this case, the cargo container 810. The sensor such as limit switch, proximity sensor, or force sensors built into the equipment module 701 help monitor the status of the positive contact and the anchoring strength, providing feedback to the forklift 770 to take necessary actions. It should be noted that despite the advantage of speed and flexibility, the strength of the magnetic force developed by the electromagnet here can be imparted by the surface smoothness, and surface roughness, and be reduced by the presence of oil film or other particles on the surface, as well as the hazardous residual magnetism, the conditions that can incur regularly in an outdoor manufacturing environment. Therefore the securement of the carrier and the suspended kit can not depend solely on the electromagnet unless extremely high-powered electromagnets are used which will undesirably increase the weight of the equipment module 701.

It should be noted that the forklift 770 can be any suitable type including but not limited to multi-directional type with side-shifter, Counterbalance Forklift with side-shifter, Side Loader, Telehandler, Rough Terrain Forklift, Pallet Jack, Reach Fork Truck. The referred lift includes but is not limited to a linear actuator, one stage or multiple-staged telescopic lifting column, aerial lifts including but not limited to articulated boom, telescopic boom, scissor lifts, vertical mast lift, actuated by electric, pneumatic or hydraulic or hybrid power.

The lift and gripper can be powered by an electric battery, hydraulic system, pneumatic compressor, or even a portable compressed liquid, air, or gas reservoir.

It should be noted that when the magnet, electromagnet, or electro-permanent magnet are deployed, their counterparts such as datum block, stopper wall, etc. must be made at least partially in ferromagnetic material, for example, a magnet or electromagnet pre-built into those datum blocks.

It should be noted that the mobile robot manipulator and its carrier can be equipped with different sensors of any suitable type including but not limited to dead reckoning, tactile and proximity sensing, triangulation ranging, collision avoidance, and position location. It may be light sensors, sound sensors, temperature sensors, contact sensors, proximity sensors (infrared IR, ultrasonic, photoresistor), distance sensors (ultrasonic, infrared, laser range, encoder, stereo camera), pressure or force sensors, tilt sensors, navigation, and positioning sensors such as GPS, digital magnetic compass, localization) acceleration sensors or accelerometers (static force and dynamic force), gyroscopes, and inertial measurement units.

The robot manipulators 740 can be any suitable type including but not limited to the articulated robot, SCARA robot, delta robot, cartesian robot, cylindrical robot, polar robot, or other types of robot arms. The nature of the control can be pre-programmed, autonomously guided, teleoperated, or even humanoid or augmenting robots, or in a human collaborative manner. The collaborative robot, sometimes also referred to as a service robot regroups all the robots included in one of the four collaboration modes (ISO 10218) including safety monitored stop, hand guiding, speed & separation monitoring, and power and force limiting. The power and force limiting type collaborative robot may have a force threshold to prevent impact with a human, usually integrating force sensors in the robot's joint or external cover, designed to stop when an external force is sensed, for example, over 150N to prevent serious injuries.

It should be noted that depending on the type of the end effector the robot manipulator carries, the robot manipulator can also be used to perform other tasks including but not limited to capture, manipulation, monitoring, inspection, shooting video, etc.

In the case of a fully automatic mobile carrier, or AMR forklift 770 is employed, the mobile robot uses Robot Operating System (ROS) as a common framework for integrating software and interacting with the hardware listed above. The manipulator operates by autonomously switching between a set of predefined states: such as waypoint navigation, 2D laser, 3D LIDAR perception, or other real-time robot vision-based alignments, IBC picking, IBC placement, IBC locking, and IBC unlocking that are triggered autonomously by sensor inputs and the status of the mission. The mobile robot manipulator is built as a state machine using the SMACH library.

Robot localization and navigation algorithm allow the mobile carrier 770 to move autonomously and safely in the railway yard and to reach a specific railcar and a corner casting of interest. It comprises two basic components:
a robot localization system that estimates the position and orientation of the mobile carrier relative to the railway yard and the particular railcar of interest;
a waypoint path planner that computes feasible paths for the robot to reach a specific railcar, shipping container, and corner casting.

For approaching a specific IBC holder and a specific corner casting of the loaded lower container, a more precise navigation method is employed in terms of a relative localization and navigation system based on the measurements of three types of sensors that will be described later in the text.

FIG. 7, FIG. 7A, FIG. 7B, and FIG. 7C depict general structural and functional principles of a robotic rail IBC handler 700 for unmanned handling of the rail IBC 900 and 900A.

As shown in FIG. 7, FIG. 7A, FIG. 7B, and FIG. 7C, the robotic rail handler 700 comprises three main elements: the mobile carrier 770 in the form of a forklift, the modular robotic equipment pallet 701, and the modular spare rail IBC pallet 730. The robotic equipment module 701 and the spare part module 730 have standardized fork openings and can be coupled in series so that the forklift can carry both of them with standard forks. The robotic equipment module 701 is anchored to the mobile carrier 770. The robotic equipment module 701 and the spare part module 730 are readily coupled and decoupled to each other by a male and female engagement means or by a magnetic force once they are held together by the mobile carrier 770.

The modular arrangement of the robotic rail IBC handler allows flexible adaption depending on the specific task performed. During rail |IBC locking and unlocking, the forklift 770 carries only robotic equipment module 701 without spare rail IBC module 730. However, during rail IBC removal or placement, the forklift carries both the module equipment pallet 701 and spare IBC pallet 730 near the corner post of the container in use. When it arrives at the desired location, it then only lifts the modular robotic equipment pallet 701 to the top of the lower container to perform the rail IBC removal or placement. leaving the spare IBC module 730 on the ground.

The rail IBC removal and placement process are configured to comprise two combined robotic pick and place processes, one relative to the corner fitting of the container in use, and the other relative to the spare rail IBC module.

To complete the first robotic pick and place manipulation relative to the spare rail IBC, the robot manipulator 740 sitting on top of the robotic equipment module 701 picks a new rail IBC from or places the held rail IBC to one of the cavities with known coordinates when the spare rail IBC module 730 is coupled with the robotic equipment module 701, and when the lockable base suspension 720 switches to locked mode and the robot 740 settles onto heavy base support with much greater inertia than the suspended kit 720.

The locked modular equipment module is then lifted to the top of the container by the forklift 770, to perform the second robotic lock and place manipulation relative to the corner fitting 819. The vibration and shock isolators 761 built into the system 700 help cushion the robot manipulator, attenuating the forces transmitted to the vibrational sensitive robot manipulator when traversing from location to location.

Three groups of distance and displacement sensors are disposed of in the robotic rail IBC handler 700,
the long range non-contact type of sensors is exemplified by the illustrated laser 2D scanner or an array of laser distance measurers 707, mounted to the suspended kit 720 of the robotic equipment module to detect the presence and approximate location of the container, the corner fitting, and the rail IBC, targeting the contours of the container and the contour of the stadium hole 817 in the corner fitting 819, and to guide to stop the mobile carrier near the corner of the container;
the close range non-contact type sensors such as eddy current sensor, laser sensor, photonic sensor, fiber optic sensor, or the contact type sensor exemplified by the arrays of limit switches 708 installed in the locking plate 714 as illustrated in FIG. 7C to determine instantly the approximate position of the robot base relative to the corner fitting 819 within a tolerance of several millimeters;
the contact type or close range non-contact type sensors 796 mounted to the gripper capable of checking the key distinguishing characteristics of corner fitting and/or the types of the rail IBC within the tolerance range identified by the previous steps.

The collection of the feedback from three groups of sensors is brought to a central control unit, and to a visual indicator monitored by the driver or by the autopilots of the forklift to enable recognition of the types of the rail IBC, detection of the position of the robot base relative to the corner fitting 819 of interest or relative to a particular cavity in the spare IBC module 730.

Certain degrees of free movement are allowed between fork 771 and fork receivable 711. This enables a self-alignment between the equipment module 701 and the corner post 818 once they are put into contact by the forklift, establishing instantly a known lateral coordinate between the robot base and the corner fitting, one of the three to be determined. The longitudinal and vertical coordinate relationships are measured by the onboard sensors, especially the limit switches.

As illustrated in FIG. 7C, there are three arrays of limit switches, two horizontal rows 708A, 708B, and a third substantially vertical column 708C. The limit switches within the 708A, 708B, and 708C are closely packed and equally spaced precisely. The distance between three arrays of the limit switches is strategically positioned so that they can detect instantly the position of the robot base relative to the edge of the corner post 818 or the edge of the stadium hole 817 in the corner fitting within a tolerance equal to or less than the gap between the limit switches within each row or column.

When the equipment module 701 and container 810 are made in contact, some of the limit switches are compressed and switched on while others remain in an off state. As the shipping container 810, the side post 818, the corner fitting, or corner casting 819, are built into standardized dimensions, a simple touch made between the equipment module 701 and the container 810 gives instantly the two-dimensional coordinates of the robot base relative to the corner post or corner fitting within a relatively small tolerance. Now all three dimensional coordinates are established, as the lateral contact already gives the third coordinate.

Such a quick and approximate position detection narrows down the scanning range of the further precise scanning by the sensors 796A, 796B, or 796C mounted to the gripper, increasing the overall speed of the position detection.

As the shipping container 810, the side post 818, the corner fitting, or corner casting 819, are built into standardized dimensions, the above speedy position detection process gives the robot manipulator a consistent starting position and posture when the mobile rail IBC handler arrives at every new location.

The contact type limit switches can be any suitable type including but not limited to whisker, roller, roller-lever, lever, and plunger.

The referred fiber optic sensor can be any suitable type, including but not limited to intrinsic or extrinsic types, preferably extrinsic types are used to measure vibration, rotation, displacement, velocity, and acceleration.

The referred eddy current sensors consist of a driver that creates an alternating current in a sensing coil at the end of a probe. The alternating current then creates an alternating magnetic field which induces smaller currents within the target material, these currents are referred to as Eddy Currents. The Eddy Currents then create an opposing magnetic field that resists the field being generated by the probe coil. The distance between the probe and the target will determine the interaction of the magnetic field. The distance between the probe and the target is then determined by the change in the field interaction and an output is produced proportional to the change in the measured distance. Eddy current sensors have a tolerance for dirt so are functional in dirty environments and are unaffected by most contaminates.

The referred photonic sensors are any suitable types including but not limited to single photon counting modules (SPCM), avalanche photodiodes, photodiodes, phototransistors, analog optoisolators, optocouplers, photocells, and others. The photonic sensors and detectors are produced by using technologies such as fiber optics, laser technology, and bio-photonic technology.

It should be noted that the above proposed position detection device and approach based on the array of limit switches can also be employed to scan the space near the rail car or the corner fitting. The limit switches used for this purpose are preferably the roller or whisker type. This approach can well be adapted to harsh weather or working condition where visual detection becomes unreliable.

As also shown in FIGS. 7A and 7B, the spare rail IBC 730 provides several cavities in multiple-level pull-out trays and a consistent fashion. The cavities take similar if not identical contours as the corner fitting, ensuring the uniform postures of the rail IBC whether they sit in the corner fitting or in the spare rail IBC module. Those cavities with known coordinates hold the rail IBC 900 or 900A in a consistent posture, simplifying the robotic pick and place manipulation programming algorithm of the rail IBC relative to the spare rail IBC stand.

The spare rail IBC module 730 has a drawer organizer structure where multiple-level of pull-out trays 733 with a uniformly shaped handle or aperture are mounted to a stand 734. Such an arrangement allows trays 733 to be filled or emptied layer by layer. The tray can be made in any suitable material including but not limited to molded plastic, welded, or cast metals such as aluminum or steel.

The spare rail IBC module 730 also provides a semi-closed protective, covering dome (not shown in the FIGURE) with an opening to allow entry and exit of the robotic equipment module 701 in action and the robotic pick and place manipulation inside the dome. The benefits of such a dome include
creating a friendly environment for the survival of the robot manipulator under harsh weather environments;
creating a controlled lighting condition surrounding the rail IBC stand to enable reliable robotic vision guidance for performing the pick and place of rail IBC from the cavities in the pull-out trays stacked on the spare rail IBC module.

As shown in FIG. 7E, FIG. 7F and FIG. 7G, a fingerless gripper 790 is provided comprising an actuator tube 793, a robot mounting tube 791, a short actuator rod 797, and a long actuator rod 798, a short stopper rod 799 that are welded together. Four screws are employed to secure the gripper to the tool flange of the robot arm 740.

The distance between the two rods is tightly controlled to match the width of the shoulder flange 902 to assure a solid grip by the two actuator rods.

The locking and unlocking of the rail IBC relative to the corner fitting are achieved in the following ways:
a pair of kickplates 793 welded on both sides of the actuator tube 792 are employed to push the handle 909 of the IBC 900 powered by the robot arm.
the mid actuator rod 798 inserted into the cone aperture 906 is employed to rotate the IBC cone and force the handle 909 that is fixed to the cone to change its angular position.

The lifting and holding of the rail IBC are achieved in the following ways:
fingerless IBC gripper holds and lifts the rail IBC 900 by the two actuator rods 797 and 798 inserted between the bottom of the top cone 901 and the top of the shoulder flange 902. This embodiment is especially useful to handle the type of rail IBC without aperture in its top cone and with a pair of bottom cone 903 and top cone 901 misaligned by an angle;
fingerless IBC gripper holds and lifts the rail IBC 900 by the mid actuator rod 798 inserted into the aperture 906 in the top cone. This embodiment is especially useful to handle the type of the rai IBC with the top cone and bottom cone essentially aligned.

Both the long and short rods have the self-releasing type of tapered tip and a section of the grounded flat chamfer at the upper round circumferential contour. The tapered tips facilitate the entry of the actuator rod into the cone aperture or self-alignment of the two rods against the shoulder flange. The grounded flat chamfer creates much more stable dual line contact support to the top cone inside the aperture, versus otherwise single line contact between the round rod and the round hole. A bumper 798W is built near the tip of the mid-actuator rod 798 to prevent accidental slip of the rail IBC during the initial IBC lifting.

A method of sure-grip is also provided to transport safely the railway IBC or other workpiece during the movement of the mobile robot to prevent accidental slipping out of the grip. The method includes tilting or flipping over immediately, by the manipulator, the position of the rail IBC relative to the gripper 790 by the robot arm 740 immediately after the end effector 790 grasps the rail IBC. Such a tilting creates a gravity-held position and is kept when the rail IBC is held by the gripper 790 until the rail IBC is located on top of the cavity 816 in the corner fitting or the cavity in tray 733, ready to be dropped.

A force sensor 794 is integrated between the gripper 790 and the tool flange of the robot arm. The force sensor 794 enables the measurement of forces and torques during the operation and force value-based controls.

A blind-test method to distinguish the type of IBC without robotic vision is established using the fingerless gripper with a force sensor as follows:
(1) push the rail IBC to the extreme right until resistance force criteria are exceeded;
(2) move the mid rod 798 along the cone aperture orientation assuming it exists and monitor the resistance in terms of force value against the travel distance of the moving rod;
(3) continue moving the mid rod until a high resistance is encountered, and determine the position of the rod tip relative to the cone coordinates;
(3a) f the travel reading exceeds the cone thickness, the IBC in question is recognized as a type bearing an aperture in the cone;
(3b) f the reading is below the cone thickness, then make the mid-rod tip move in a spiral manner to enlarge the search range, if the travel along the aperture direction remains limited while the resistance exceeds the force criterion, the IBC in question is recognized as type bearing no aperture, for example, the WMEC;
(4) lift the mid rod after it is successfully inserted inside the aperture, and continue to raise the mid rod in small increments. until either a high resistance is encountered or significant travel is reached.
(4a) if the vertical travel achieved exceeds the height of the IBC, under a minimum resistance, the rail IBC is recognized as the type with aligned top and bottom cone, for example, P&H;
(4b) if the resistance exceeds a high force value while the vertical travel remains minimum, the rail IBC is recognized as a type made by BUFFER USA;
(5) make the rail IBC (4b) rotated in a clockwise direction until it reaches a high torque criterion, stop rotating and lift the rail IBC in question;
(6) For 3 (b) WMEC type, the gripper adjust its orientation to use the two actuator rod to lift the rail IBC.

A similar blind-test approach, with a series of go, no-go steps, based on the feedback of the array of limit switches, force sensors, or close range sensors such as eddy current, fiber optic, or photonic sensors is foreseen to perform other steps of rail IBC handling relative to the spare IBC module and the corner fitting. Such a blind test approach, similar to the operation of a coordinate measuring machine (CMM), is especially useful in the working environment where the conventional robot vision systems fail to perform reliable detection.

As shown in FIG. 7E, a short stopper rod 799 is integrated into the actuator tube to prevent the top cone from rotating, escaping from the grip of the two rods.

As shown in FIG. 7F, an optional mechanical deicing tool 795 with spikes, together with a spray nozzle delivering granular or liquid deicing agents, and a hot air blowing nozzle are presented. A mixture of granular and liquid deicing material may be created at the end of the nozzle. The granular deicing material may contain sodium chloride, calcium chloride, magnesium chloride, potassium chloride, and calcium magnesium acetate (CMA). The liquid deicer can be any suitable type including but not limited to fast-working type 1, thickened type 2, viscous type 3, longer-lasting type 4, and liquid Brinell.

A spring-loaded block with multiple spikes elastically attached to the deicing rod is foreseen to make the deicing tool more geometrically tolerant and mechanically effective. The spikes built into the deicing rod rub against the frozen IBC in reciprocal movement by the robot to remove the surface ice from the corner fitting and introduce vibrations to loosen the frozen IBC bonded to the corner fitting. Liquid deicing agent and/or granular solid deicer material sprayed on the frozen surface accelerate the deicing process.

The additional magnet, electromagnet, and electro-permanent magnet may be incorporated into the gripper 790 to assist the reliable grasp of the rail IBC. One or multiple fingers may also be incorporated into the gripper.

A robot vision unit with the camera may be attached to the tool flange of the manipulator or be part of the end effector or the gripper, enabling the acquisition of environmental information corresponding to the railcar, the shipping container, the IBC holder as well as other objects or devices onboard the mobile robot, visual inspection, and visual servoing, a technique that uses feedback information extracted from the robot vision unit to control the motion of the aerial lift, aerial anchor, robot manipulator, and the end effector.

Such a robot vision unit is preferred, in a combination of the controlled lighting under a semi-closed enclosure surrounding the spare rail IBC stands, to enable the robot manipulator 740 to perform pick and place operations relative to the spare rail IBC stand 730.

The robot vision units implemented in the invention can be any suitable type of 2D or 3D system and methodology based on an optical geometry-based monocular/binocular camera or the RGB-D camera based on time of flight, with the aid of a lighting system to reduce reflection or shadow in the outdoor environment. The lighting sources may be LED, quartz halogen, Xenon, and fluorescent activated in a continuous or pulsed flashing or strobing manner.

Referring to FIG. 7G, several optional locations 796A, 796B, and 796C are given for installation of contact type sensor or non-contact type distance sensor in actuator tube 792 of the gripper 790. Combined with the multi-axis precision movement capability of the robot arm, those sensors installed in the gripper are capable of scanning and checking the distinguishing geometric characteristics of the corner fitting, and the rail IBC, and guide the robot arm movement, replacing the role of the robot vision in bad weather conditions.

As shown in FIG. 7H and FIG. 7J, two types of suspension systems are provided to prevent the transfer of the road vehicle vibration and shock input into the sensitive robotic equipment, sensors, and electronic control devices. In terms of functional principle, both suspension systems, one for the robot arm 740, and the other for the control box 746 use wire rope shock isolators and elastomeric vibration isolators as shown in FIG. 6, both are supported by the same base support 710. The difference between the two lies in that one type has an integrated locking mechanism while the other type is built without. The integrated locking mechanism enables the robot arm 740 to function in either transport or manipulation, two functional modes.

The base support 710 comprises a welded frame 712, a pair of locking plates 714, one pair of electric cylinders 718 connecting to the locking plates 714, and a cylinder mounting channel 713 welded to frame 712. The rigid welded frame 712 is made in heavy gauge steel tubes. Two tubes 711 at the bottom of the frame serve as receivables for the forks 771. The cylinder mounting channel 713 serves as a mounting seat and protective shield for the pair of electric cylinders 718.

In addition to the vertical support by the fork 771, the base support 710 is elastically attached to the forklift 770 laterally, leaving sufficient room for the displacement of the base support relative to the fork 771, enabling compliance self-aligning between the base support 710 and an external datum, in this case, the corner post 818 or the corner fitting 819 once they are put into forceful contact by the forklift 770, assisted by the electromagnet 704 shown in FIG. 7K.

It should be noted that additional spring box or suspension at the joint between forks 771 and fork receivable 711 or at the level of forklift are foreseen to mitigate the vibration and shock input.

The suspended kit 720 of the lockable base suspension comprises a rigidly welded or mechanically assembled frame made in suitable lightweight high-strength material including but not limited to aluminum alloy, steel alloy, and composite material.

Two rows of wire rope shock isolators 667A and 667B, and multiple elastomers floating mount vibration isolators identical in construction and functional principles to the ones shown in FIG. 6 are provided to connect the suspended kit 720 with the base support 710. The wire rope springs 667A and 667B are preloaded in substantially compression orientation. The suspended kit 720 provides a pair of upper rails to connect the mounting block 668 of the wire rope isolators while the base support 710 provides a pair of lower rails to connect the mounting block 669 of the same isolators from the bottom.

Two wire rope shock isolators 667C and multiple elastomers floating mount vibration isolators, identical in construction and functional principles to the ones shown in FIG. 6, are provided to connect the electronic control box 746 with an elevated stand attached to the base support 710. The wire rope springs 667C are loaded in a 45-degree compression/roll orientation.

It should be noted that the wire rope isolators may be arranged in other suitable manners including but not limited to fixed shear, and fixed roll, instead of 45-degree compression/roll or compression orientation demonstrated.

Sufficient gaps are reserved surrounding the two suspended kits to ensure that they can move freely within a three dimensional space equal to or more than the maximum spring deflection of the wire rope isolators, without interferences.

Two pairs of male cones 715 are mounted to the mounting channel 713 and another two pairs of male cones 725 are mounted to the frame of the suspended kit 720. An equal number of female cone-shaped holes 716 and 726 are disposed of in the locking plates 714 and in alignment with the male cones 715 and 725. The coupling and decoupling of the male cone and female cone holes actuated by linear electric cylinders 718 switches on and off the locking mechanism giving birth to an adaptable robotic suspension.

It should be noted that there is a significant increase in the system inertia associated with the robot arm under the coupled mode in comparison with the decoupled mode. The swift change of the inertia allows the employment of a compact suspension system to be used with the robot arm in the transport mode while providing a heavier and rigid base foundation to the robot arm 740 once it starts its robotic manipulation in the working mode.

It should be noted that instead of a male cone and cone-shaped female hole, other suitable types of coupling means can be used, for example, Philips-screw-like bump and groove pairs. The coupling and decoupling may also be achieved by frictional force using frictional pads, or by magnetic force using permanent magnets or electromagnets.

The power source, in this case, the battery 747 is placed underneath the electric control box and cushioned by an elastomer pad for vibration and shock isolation.

The battery 747, or the battery plus the second suspended kit for isolating the electric control box 746 may be placed on the side of the forklift 770, instead of compacting them within the equipment module. This will give more free space for the robot arm manipulation.

The embodiment of a two-point suspension is also foreseen and presented in FIG. 7A and FIG. 7B. In addition to the lockable cushioned support at the robot base 741, a secondary cushioned support is provided at the elbow joint 743 of the robot arm. The Robot base 741 sits on a seat at point 724 of the suspended frame, while the elbow joint 743 rests at point 725 of the suspended frame.

As shown in FIG. 7A and FIG. 7B, the robot arm 740 is folded tightly in a fetal position during the transport and places its center of gravity in the robot close to the robot base 741, meanwhile avoiding the singularity position.

As shown in FIG. 7B, the robot arm 740 comprises a relatively heavy and strong lower link 748 connecting the shoulder joint 742 near the base 741 with the elbow joint 743. If the robot arm 740 is solely supported at base 741, it tends to topple over due to an inherent imbalance, resulting in tipping-over torque acting at the base joint, resulting in inherent instability. The second suspension seat at the elbow joint 743 helps correct this inherent instability and reduce the stress level at the base during the transport mode.

The articulated robot manipulator incorporated in this invention, in general, can be divided into two sections: the arm consisting of several large and long arms linked by joints, and the wrist consisting of several compact members linked by joints and ending with a tool flange where an end effector is attached. The arm is employed to position the end-effector and workpiece in the manipulator's workspace, while the wrist is used to orient the end effector and the workpiece at the work location. It should be noted that the second unlockable suspension support may locate at other joints or sections of the robot manipulator instead of the elbow joint and more unlockable secondary suspension seats may be provided without disparting from the same spirit of the present invention.

FIG. 7K and FIG. 7L depict an alternative embodiment of the present invention where the parallel-gripping clamp is provided by four inline-type electric cylinders 718. At each end, two actuators 718 arranged diagonally rest in the extended position and are ready to pull the locking plates 714 from the extended positions inwardly until the male cone and female cone holes are coupled together. A multiple-cylinder synchronizer may be added to smooth the actuation.

As shown in FIG. 7K and FIG. 7L, instead of an extended stationary beam to support locking plates 714 from the bottom, a pair of telescoping guide tubes 719 may be attached on each side of the locking plate and assembled into the longitudinal tubes of the support base 710. When the locking plates are pulled inwardly to achieve the clamping action to lock the suspended kit, guide tube 719 follows and slides inside the structural longitudinal tubes.

The robot base support seat 741 is intentionally located near one end of equipment module 701. The equipment module 701 engages with container 810 from the proximal end. An electromagnet 704 is integrated into the locking plate 714 at the proximate end, helping enhance the anchoring strength and self-alignment between the equipment module 701 and the container. The electromagnet is electrically energized after the engagement is made mechanically by the forklift.

The magnets incorporated into the system may be any suitable type of permanent magnets, electromagnets, pneumatically controlled permanent magnets, or electro-permanent magnets (electrically controlled or operated permanent magnets) that can be switched on or off depending on the required functions. The permanent magnets may be of any suitable types, either in rigid or flexible shape, including but not limited to neodymium iron boron, samarium cobalt, alnico, ceramic or ferrite magnets, other rare-earth magnets,

The linear locking actuator 718 can be any suitable type such as an electric, hydraulic, pneumatic, thermal magnetic, mechanical, or supercoiled polymer. The actuator may also be a rotary type.

As shown in FIG. 7M, a heating and ventilation system is provided to the robotic rail handler 700 utilizing the afterheat from either the diesel engine or waste heat from the electric battery that powered the mobile carrier, or forklift 770.

The depicted system is incorporated inside the rear case of the forklift where the engine is located. A coolant circulation depicted by the white arrows is achieved by a liquid or water pump 773. The coolant pass through the reservation tank 774 surrounding the engine or battery bringing with it the intensive afterheat generated by the engine to the radiator 775 to be dissipated into the atmosphere, assisted by the fan 772. Some of the hot coolants make a detour passing through the heater core 777 located near the entry to the driver cabin and/or entry to the robot suit, where the heat is dissipated to the blowing air powered by the fan 776. The warm air flow helps prevent the robot, sensor, and other sensitive electronic devices enclosed inside the suit from being frozen under cold working conditions. The flow of the hot coolant is regulated by the heater control valve and/or a blend door, assisted by a thermostat 779 which monitors the temperatures.

The robot arm 740, the electric control box 746, other sensors, and the robot battery 747 are wrapped around by enclosures either in rigid cases or flexible suits with protective thermal insulation. The warm air flow is fed into the inside of those enclosures connected by air hoses with insulation. The continuous flow of warm air circulates inside the enclosure, keeping the equipment warm and dry in cold weather. Part of the flow of the warm air is directed to the forklift cabin where the human driver or the autopilot is located. Part of the flow of the warm air is also directed to the vent created near the gripper 790 or connected to the deicing tool 795 to help soften the frozen rail IBC and assist in mechanical and chemical deicing of the rail IBC frozen in the corner fitting,

Additional thermal elements such as an electric heater, and a cooling compressor for air conditioning powered directly by a battery may also be added to either supplement the heating requirement in extremely cold weather or to achieve full climate control for sensitive devices.

In FIG. 7M, the forklift cabin, and the enclosures for robotic equipment are placed in series along the path of the hot air flow through air hoses. It should be noted that they may be arranged in parallel or other suitable fashion.

Passive heat transfer devices such as multiple heat pipes may be integrated into the above-mentioned climate control system. For example, a heat pipe employing phase transition for efficient heat transfer may be attached to the heat sinks mounted to the electric battery of the mobile robot at one end and connected to the heat spreaders mounted to the interior of the docking station or the deicing tool at the gripper 790 at the other end, help accelerate the dissipation of the heat generated from the electric battery, especially in hot weather, and help keep the encased sensitive equipment warm or accelerate the deicing process in cold weather.

Although the present invention deals mainly with outdoor harsh working conditions, the elements of the above invention can also be applied to indoor conditions. For example, mobile robots running on mecanum wheels are subjected to vibration at high running speeds even on a smooth indoor floor. The lockable base suspension is useful in this case to protect those mobile robots at high operational speeds.

As a general note, the equipment and the device applied in the present invention have a proper level of sealing with effectiveness against the intrusion of foreign bodies such as tools, dirt, dust, water, or liquid. according to the selected ingression protection (IP) rating between IP33 and IP68 depending on the additional protective gears offered.

The present invention has been described in connection with the preferred and alternate embodiments of the various figures. It is to be understood that other similar embodiments and other combinations of the elements of the present invention may be used, or modifications and additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A mobile manipulator work cell system for manipulating container connectors, capable of working in outdoor environments, comprising
a plurality of containers located in a plurality of worksites, each container having a container frame and a plurality of corner castings with apertures, containers sharing common geometric features associated with their container frames and corner castings,
a plurality of container connectors, each having a connector flange engageable with the corner casting, a top cone being rotatable relative to the connector flange, a bottom cone and the top cone being insertable into the aperture, the container connector capable of being locked in place in the aperture or being unlocked by rotation of the top cone relative to the connector flange,
a manipulator comprising a controller, an arm with an arm base at one end and a gripper at the other end,
and a flexible cover enveloping at least a portion of the manipulator, creating an internal environment between the flexible cover and the portion of the manipulator, the arm being capable of, under the command of the controller, performing at least one manipulation of the container connector programmed in reference to the common geometric feature, the manipulation including picking up and hanging the container connector by the top cone, and rotating the top cone relative to the connector flange when the movement of the connector flange is restricted,
a mobile lift comprising a mobile base, a lift mounted to the mobile base, a power unit that generates waste heat or after heat, and a heating and ventilation unit capable of directing, absorbing, and distributing the waste heat or after heat to at least the internal environment for keeping the manipulator working in outdoor environments, the lift having a movable end to where a dual mode lockable suspension unit and the arm are mounted,
the dual mode lockable suspension unit being capable of either working in a suspension mode to protect the arm from shock and vibration or in a locking mode to stabilize the arm, the mobile lift being capable of moving, in multi-directions, the movable end, powered by a lift actuator unit.

2. The mobile manipulator work cell system of claim 1,
wherein the gripper provides a multi-pronged hook with at least a pair of rods parallel to each other, at least one rod with a tapered rod head, being capable of fitting into an opening in the top cone for the type of container connector having the opening, the pair of rods being arranged in a way that allows them to fit by the two opposite sides of the connector flange, the manipulator being capable of picking up and hanging the container connector by the top cone
by inserting one rod into the opening in the top cone for the type of container connector that has the opening in its top cone, or
by inserting the pair of rods under the top cone and by the two opposite sides of the connector flange when the top cone is unaligned with the connector flange;
wherein the gripper provides a safety lock in the form of a third rod parallel to the pair of rods, to keep the top cone unaligned with the connector flange when the container connector is picked up or hung by the pair of rods;
wherein the dual mode lockable suspension unit comprises
a first shock and vibration isolator including a suspended frame to where the arm is mounted, a carrier frame mounted to the movable end of the lift, and at least one wire rope isolator mounted between the suspended frame and the carrier frame capable of attenuating shock and vibration acting on the arm,
one elastomeric isolator mounted in series or bound with the first shock and vibration isolator capable of enhancing the attenuation of the shock and vibration acting on the arm;
a mode switch capable of interrupting and resuming the function of the first shock and vibration isolator, and changing the working mode of the dual mode lockable suspension unit between the suspension mode and the locking mode;
wherein the mode switch comprises at least one coupling actuator, one pair of side frames, and a plurality of male and female self-aligning coupler pairs mounted to the side frame, the suspended frame, and the carrier frame, the male and female self-aligning coupler pairs being aligned and interconnected when the coupling actuator is powered on, binding the suspended frame, the carrier frame, and the side frame pair together, and creating combined inertia to resist the movement of the arm base;
wherein the mobile lift is a multi-directional forklift having three wheels capable of rotating independently.

3. The mobile manipulator work cell system of claim 2,
wherein the dual mode lockable suspension unit has an anchor with a magnet or electromagnet, capable of releasably securing to the container frame for stabilizing the arm base and aligning the arm base with the container frame for expediting the calibration of the manipulator before performing the desired manipulation;
wherein the manipulator is a jointed arm robot with the gripper, one end effector vision sensor, and one force detector, the end effector vision sensor being capable of a visual inspection and guiding the rod as a trigger probe to make a physical inspection of the container and the container connector;
wherein the manipulator is capable of calibration the motion of the manipulator by the combined visual and physical inspection of the container or the container connector.

4. The mobile manipulator work cell system of claim 2,
wherein the mobile base has at least one connector holder unit capable of holding at least one container connector by the top or bottom surface of the connector flange, the connector holder unit being capable of releasably coupling to the mobile base with a consistent position and pose.

5. The mobile manipulator work cell system of claim second shock and vibration isolator mounted between the mobile carrier and the controller to protect the controller from shock and vibration, the mobile carrier providing an enclosure enveloping at least partially the controller and a driver, or the controller and autopilot, the heating and ventilation unit directing the waste heat or after heat to the interior of the enclosure and the internal environment.

6. The mobile manipulator work cell system of claim 1,
wherein the mobile manipulator has a deicing device to reduce the force required during the manipulation of a frozen container connector in cold environments, the deicing device being capable of directing a flow of deicing chemicals to the frozen container connector.

7. A mobile manipulator with a dual mode lockable suspension unit for protection of the manipulator against shock and vibration, comprising
a mobile carrier with a navigation system configured to move among a plurality of worksites,
a manipulator capable of performing desired manipulation tasks in the worksite, the manipulator having an arm with an arm base at one end and at least an end effector at the other end, and a controller,
a dual mode lockable suspension unit capable of either working in a suspension mode to protect the arm from shock and vibration or in a locking mode to bind the arm base and the mobile carrier together for stabilizing the arm, comprising
a first shock and vibration isolator mounted between the mobile carrier and the arm base capable of attenuating shock and vibration acting on the arm and the end effector,
a mode switch capable of interrupting and resuming the function of the first shock and vibration isolator, and changing the working mode of the dual mode lockable suspension unit between the suspension mode and the locking mode.

8. The mobile manipulator of claim 7,
wherein a second shock and vibration isolator is mounted in between the mobile carrier and the controller to protect the controller from shock and vibration;
wherein the first shock and vibration isolator is capable of providing a first suspension support to the arm base and a second suspension support to another portion of the arm or the end effector.

9. The mobile manipulator of claim 7,
wherein the first shock and vibration isolator comprises a suspended frame to where the arm base is mounted, a carrier frame mounted, to the mobile carrier, and at least one wire rope isolator mounted between the suspended frame and the carrier frame.

10. The mobile manipulator of claim 9,
wherein the dual mode lockable suspension unit includes at least one elastomeric isolator mounted in series or bound with the wire rope isolator, the elastomeric isolator being capable of enhancing the attenuation of the shock and vibration acting on the arm and the end effector.

11. The mobile manipulator of claim 9,
wherein the mode switch has at least one coupling actuator, one pair of side frames, and a plurality of male and female self-aligning coupler pairs mounted to the side frame, the suspended frame, and the carrier frame, the male and female self-aligning coupler pairs being aligned and interconnected when the coupling actuator is powered on, binding the suspended frame, the carrier frame, and the side frame pair together, and creating combined inertia to resist the movement of the arm base.

12. The mobile manipulator of claim 9,
wherein the mobile carrier is a mobile lift that comprises
a mobile base,
a lift mounted to the mobile base having a movable end to where the carrier frame is mounted,
the mobile lift being capable of moving, in multi-directions, the movable end, powered by a lift actuator unit.

13. The mobile manipulator of claim 7,
wherein the dual mode lockable suspension unit or the arm base has an anchor capable of releasably securing to a stationary object in the worksite, binding the arm base with the stationary object for stabilizing the arm base when the arm performs the desired manipulation;
wherein the dual mode lockable suspension unit is flexibly mounted and releasably bound to the mobile carrier by a frame lock, the frame lock having two working modes, a deactivated frame lock releasing the dual mode lockable suspension unit for free alignment movement and a re-activated frame lock preserving the aligned status.

14. The mobile manipulator of claim 13,
wherein the manipulator is a jointed arm robot with at least one end effector;
wherein the stationary object has a hole with an internal gaugeable geometric feature of a known shape that is at least partially protected by the hole;
wherein the desired manipulation is programmed in reference to the internal gaugeable geometric feature;
wherein the anchor has a gauge capable of inspecting the internal gaugeable geometric feature;
wherein the anchor and the stationary object together create a conditioned inspection environment when the anchor is releasably secured to the stationary object;
wherein the manipulator is capable of calibrating the motion of the manipulator by the inspection of the internal gaugeable geometric feature.

15. The mobile manipulator of claim 7,
wherein the manipulator is a jointed arm robot with at least one end effector;
wherein the desired manipulation is programmed in reference to a gaugeable geometric feature of a known shape in a stationary object in the worksite;
wherein the manipulator comprises an end effector with a rod, an end effector vision sensor, and a force detector capable of detecting the force acting on the rod, the end effector vision sensor being capable of visually inspecting the gaugeable geometric feature, and guiding the rod as a trigger probe to inspect physically the gaugeable geometric feature.

16. A manipulator for manipulating a container connector, comprising
a controller, an arm with an arm base at one end and a gripper at the other end,
the arm being capable of manipulating a container connector under the command of the controller,
the container connector having a connector flange and, a top cone being rotatable relative to the connector flange, the container connector being capable of switching between a locked status and an unlocked status by rotation of the top cone relative to the connector flange,
the arm being capable of, picking up and hanging the container connector by the top cone, and rotating the top cone relative to the connector flange when the movement of the connector flange is restricted.

17. The manipulator of claim 16,
wherein the gripper provides a multi-pronged hook with at least a pair of rods parallel to each other, at least one rod being capable of fitting into an opening in the top cone for the type of container connector that has the opening, the pair of rods being arranged in a way that allows them to fit by the two opposite sides of the connector flange, the manipulator being capable of picking up and hanging the container connector by the top cone,
by inserting one rod into the opening in the top cone for the type of container connector that has the opening in its top cone, or
by inserting the pair of rods under the top cone and by the two opposite sides of the connector flange when the top cone is unaligned with the connector flange.

18. The manipulator of claim 17, wherein the gripper provides a safety lock to keep the top cone unaligned with the connector flange when the container connector is picked up or hung by the pair of rods inserted under the top cone.

19. The manipulator of claim 18,
wherein the gripper provides a safety lock in the form of a round rod parallel to the pair of rods, to keep the top cone unaligned with the connector flange when the container connector is picked up or hung by the pair of rods inserted under the top cone;
wherein the pair of rods are round rods with tapered heads and distanced with a gap of between 2.2 and 4.0 inches.

20. The manipulator of claim 16,
wherein the manipulator is a jointed arm robot with the gripper and a force detector capable of detecting the force acting on the gripper, the manipulator being capable of recognizing the type of container connector, confirming the locked and unlocked status of the container connector according to the detected values of the force.
